(19) United States
(12) Patent Application Publication
(10) Pub. No.: US 2024/0345361 A1
(43) Pub. Date: Oct. 17, 2024

(54) TELESCOPE

(71) Applicant: SEVUN, Pessac (FR)

(72) Inventors: Paul Gheno, Thiviers (FR); Damien Roy, Moulis en Médoc (FR)

(73) Assignee: SEVUN, Pessac (FR)

(21) Appl. No.: 18/294,300

(22) PCT Filed: Jun. 30, 2022
(86) PCT No.: PCT/FR2022/051310

§ 371 Date: Feb. 1, 2024

(30) Foreign Application Priority Data
Aug. 3, 2021 (FR) 2108447

(51) Int. Cl. G02B 7/183; G02B 7/182; G02B 7/198; G02B 23/06; G02B 23/16; G02B 23/24

(52) U.S. Cl. CPC G02B 7/183; G02B 7/1827; G02B 7/198; G02B 23/06; G02B 23/16; G02B 23/2484

(57) ABSTRACT

The telescope has a primary optical system (11) which includes a primary mirror carrier (113) for receiving a primary mirror (7); a secondary optical system (12) which includes a secondary mirror carrier (121) for receiving a secondary mirror (8); and a spacing adjustment system (13) for adjusting the distance between the primary mirror carrier (113) and the secondary mirror carrier (121). The primary optical system (11) includes a primary mirror holding system (3) for holding a primary mirror (7) on the primary mirror carrier (113). The primary mirror holding system (3) is adjustable so that different sizes of the space for receiving the primary mirror on the primary mirror carrier (113) can be defined.

### FIELD OF THE INVENTION

The present invention is generally concerned with telescopes.

### PRIOR ART

A telescope is an optical instrument enabling perception of individual celestial objects that are difficultly perceptible or invisible to the naked eye.

Known from the prior art are reflector telescopes provided with for example parabolic concave primary mirrors that collect photons and then return them to a focal point known as the “image focus”. The convergent beam can then be sent to an eyepiece with the aid of a secondary mirror that is plane.

However, it is found that if the astronomer wishes to evolve their practise to be able to observe some objects in more detail they have to buy a new telescope that enables more light to be collected, which represents a high financial investment.

There is known from the document U.S. Pat. No. 6,061,175 a telescope designed to receive a primary mirror mounted to pivot about an axis orthogonal to the longitudinal axis of the telescope to be able to use one or the other of the opposite faces of the primary mirror.

The opposite faces of the primary mirror have different curvatures so that this telescope offers the benefit of two different focal lengths and therefore makes it possible to vary the magnitude of the object observed between two sizes.

However, this kind of telescope does not enable the light collected to be increased. Thus if the primary mirror is pivoted to use the face of the primary mirror that magnifies the observed object the light collected remains the same as that obtained with the other face of the primary mirror with the result that the astronomer is not able to observe the object in more detail.

The present invention has for object to propose a new telescope making it possible to alleviate some or all of the problems described hereinabove.

### SUMMARY OF THE INVENTION

To this end the invention has for object a telescope including:
a primary optical system including a primary mirror support for receiving a primary mirror, also known as an objective;
a secondary optical system including a secondary mirror support for receiving a secondary mirror; and
a separation adjustment system enabling adjustment of the distance between the primary mirror support and the secondary mirror support;
   characterized in that, the primary optical system including a primary mirror retaining system enabling retention of a primary mirror on the primary mirror support, the primary mirror retaining system is adjustable in such a manner as to be able to delimit different sizes of the space to receive the primary mirror on the primary mirror support.

This kind of telescope design that includes a system for retaining the primary mirror that is adjustable in such a manner as to be able to receive and to hold different sizes of primary mirror provides an easy way to change the primary mirror so as to be able to adapt the quantity of light collected to the required level of detail observed.

The telescope may also have one or more of the following features in any technically permissible combination.

In accordance with an optional feature of the invention the separation adjustment system includes:
a system of telescopic tubes comprising one or more interior telescopic tubes mounted to slide relative to one or more exterior telescopic tubes, and
a mechanism for driving the interior telescopic tube or tubes relative to the exterior telescopic tube or tubes.

In accordance with an optional feature of the invention the primary optical system, the secondary optical system and the separation adjustment system form an optical assembly that has a longitudinal axis, and the telescope also includes a support structure that includes:
a foot, also referred to as a fork; and
a connecting body, also referred to as a fork-block, that carries the optical system, said fork-block being articulated to the fork about an axis orthogonal to the longitudinal axis of the optical assembly.

In accordance with an optional feature of the invention the telescope includes an adjustment system for balancing the optical assembly relative to the support structure by sliding the optical assembly parallel to its longitudinal axis.

In accordance with an optional feature of the invention the balancing adjustment system includes a rack system carried by the exterior tube or tubes of the telescopic tube system and a drive system carried by the fork-block.

In accordance with an optional feature of the invention the adjustable retaining system of the primary mirror includes a plurality of retaining devices mounted to be mobile, preferably continuously mobile, for example along slides, between an apart position and a together position relative to one another to enable delimitation of different sizes of the space for receiving the primary mirror.

In accordance with an optional feature of the invention each retaining device is provided with a locking mechanism, for example formed by a nut-and-bolt type assembly cooperating with a groove formed in the support of the primary mirror, to enable locking of the position of the retaining device on the support of the primary mirror.

In accordance with an optional feature of the invention each retaining device includes a lateral jaw that is movable on the support of the primary mirror to come into abutment against the edge of the primary mirror and a top jaw movable relative to the lateral jaw to come into abutment against a reflecting face of the primary mirror.

In accordance with an optional feature of the invention the secondary optical system includes at least one, preferably several, observation orifice(s) to enable observation of the secondary mirror.

In accordance with an optional feature of the invention the secondary optical system includes a mechanism for orienting the secondary mirror toward any one of the observation orifice(s), the orientation mechanism including for example a motor coupled to a shaft to which the secondary mirror is fixed.

In accordance with an optional feature of the invention the telescope includes at least one of the following observation devices:
an eyepiece support for direct by eye observation;
a photography reflex box; and
a CCD-type video camera;
   the or each observation device being associated with an observation orifice of the secondary optical system toward which the secondary mirror is oriented or orientable.

In accordance with an optional feature of the invention the telescope includes said secondary mirror.

In accordance with an optional feature of the invention the telescope includes said primary mirror.

The invention also concerns a method of mounting a second primary mirror in place of a first primary mirror in a telescope conforming to any one of the embodiments proposed hereinabove, the telescope including a secondary mirror carried by the secondary mirror support, the method including the following steps:
deactivation of the adjustable retaining system to remove the first primary mirror from the primary mirror support of the primary optical system;
adjustment of the retaining system to position the second primary mirror and to retain it on the support of the primary mirror of the primary optical system;
adjustment of the separation between the second primary mirror and the secondary mirror as a function of at least one dimension, preferably at least the diameter, of the second primary mirror.

In accordance with an optional feature of the invention the method also includes the step of adjustment of the balance position of the optical assembly that includes the primary optical system, the separation adjustment system and the secondary optical system relative to a support structure that said optical assembly carries.

This kind of method therefore enables replacement of a given primary mirror with another primary mirror of greater diameter without having to change the whole of the telescope.

Indeed, the adjustable retaining system enables the new primary mirror to be received and retained and the separation adjustment system enables adjustment of the distance between the new primary mirror and the secondary mirror to adjust the focal length of the telescope as a function of the diameter of the new primary mirror. Furthermore, at the time of purchasing the telescope the user can select the primary mirror that they wish to use, for example a small primary mirror of low cost, to get started in astronomy, while later having the possibility to choose another primary mirror of greater size, to observe objects in more detail.

### BRIEF DESCRIPTION OF THE DRAWINGS

Other features and advantages of the invention will become clearer from the following purely illustrative and non-limiting description that must be read with reference to the appended drawings, in which:

FIG. 1 is a perspective view of the optical assembly of a telescope in accordance with one embodiment of the invention, the optical assembly being fitted with a primary mirror of small size;

FIG. 2 is a side view of the optical assembly from FIG. 1 carried by a support structure;

FIG. 3 is a perspective view of the telescope optical assembly from FIG. 1, the optical assembly being fitted with a primary mirror of larger size, the distance between the primary mirror and the secondary mirror being adapted accordingly;

FIG. 4 is a side view of the optical assembly from FIG. 3 carried by the support structure, the position balancing the optical assembly relative to the support structure being matched to the primary mirror of greater size;

FIG. 5 is a perspective view of the support structure of the optical assembly of the telescope that includes a base and a foot, also known as a fork, to which is coupled a device, also known as a fork-block, that carries the optical assembly of the telescope;

FIG. 6 is a perspective view of the fork-block through which extends a system of telescopic tubes, the figure showing a drive system included in the fork-block configured to cooperate with a rack system carried by the exterior tubes of the system of telescopic tubes to enable movement of the position of the optical assembly relative to the fork-block in order to balance the telescope;

FIG. 7 is a perspective view of the secondary optical system of the optical assembly of the telescope that includes a secondary mirror that can be oriented toward different observation orifices;

FIG. 8 is a perspective view of the primary mirror support plate equipped with the adjustable system retaining the mirror in an active position of retaining a mirror on the plate;

FIG. 9 is a side view of the primary mirror support plate equipped with the adjustable system from FIG. 8 for retaining the mirror;

FIG. 10 is a flowchart showing steps of a method of mounting a primary mirror in a telescope in accordance with one embodiment of the invention.

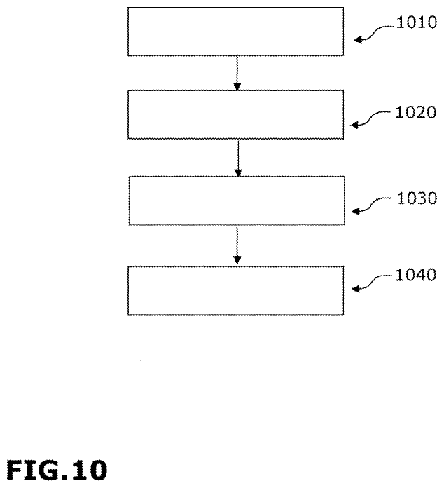

### DETAILED DESCRIPTION

The concept of the invention is described more fully hereinafter with reference to the appended drawings, in which embodiments of the concept of the invention are shown. In the drawings the sizes and the relative sizes of the components may be exaggerated for clarity. Similar numbers refer to similar elements in all the drawings. However, this concept of the invention may be implemented in many different forms and should not be interpreted as being limited to the embodiments disclosed here. Instead, these embodiments are proposed so that this description is complete and communicates to persons skilled in the art the extent of the concept of the invention.

Any reference anywhere in the specification to “an embodiment” means that a functionality, a structure or a particular feature described with reference to one embodiment is included in at least one embodiment of the present invention. Thus the expression “in one embodiment” appearing at various places throughout the specification does not necessarily refer to the same embodiment. Furthermore, particular features, functionalities and structures may be combined in any appropriate manner in one or more embodiments.

### General Description

The focal length expressed in millimeters represents the distance between the primary mirror, also referred to as the objective, and the focus of the telescope, at which the secondary mirror is situated.

The longer the focal length of a telescope, the higher the magnifications that it allows, at the price of reduced visual field and brightness. Long focal lengths are mainly used to study planetary surfaces and small objects whereas shorter focal lengths are chosen to observe or to photograph larger objects in deep space.

Referring to the figures, there has been represented a reflector telescope that enables selective reception of different sizes of primary mirrors to enable the telescope to be adapted to the requirements of the astronomer without having to replace the whole telescope.

The telescope therefore has a modular aspect enabling the user to choose the primary mirror that they wish to use and for example to replace one primary mirror with another primary mirror of greater size to be able to collect more light and thus enable the user to view more details of the object that they wish to observe with the telescope.

This telescope therefore makes it possible to change the primary mirror for another primary mirror of different diameter, thickness and/or curvature.

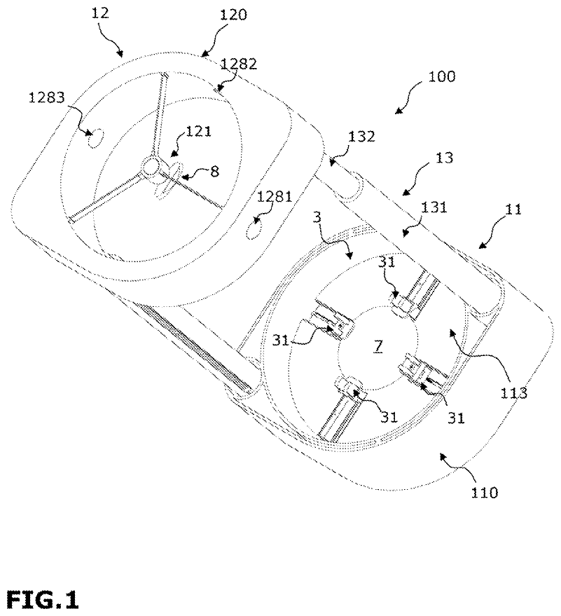

As depicted in FIG. 1 the telescope 1 comprises an optical assembly 100 carried by a support structure 900.

The optical assembly 100 includes a primary optical system 11 that includes a support 113 to receive a primary mirror 7.

The primary mirror is concave so that it reflects photons to a point known as the “image focus” or focal point. The primary mirror telescope enables “collection” of light. The greater the area of the primary mirror the greater the quantity of light collected, and therefore the more luminous the object observed and the more visible its details to the observer. In other words, the larger the primary mirror, and thus the more light it collects, the finer the observation of details of planetary structures and of objects in deep space that are not very luminous and of small apparent size.

The optical system 100 also includes a secondary optical system 12 that receives the secondary mirror 8. The secondary mirror is intended to be positioned at the image focus of the primary mirror.

As described in detail hereinafter, the primary optical system 11 makes it possible to receive different sizes of primary mirror therefore corresponding to different focal lengths.

The optical assembly 100 also includes a separation adjustment system 13 for adjusting the distance between the support 113 of the primary mirror 7 and the support 121 of the secondary mirror 8 and therefore to adjust the distance between the primary mirror 7 and the secondary mirror 8 to be able to position the secondary mirror 8 at the focal point of the primary mirror 7.

### Primary Optical System

The primary optical system includes a body 110 that carries the support 113 receiving the primary mirror 7. In the example depicted in the figures the support 113 for receiving the primary mirror 7 is a plate.

In accordance with one particular aspect the primary optical system 11 includes a mechanism (not represented) for adjusting the orientation of the support 113 to enable the primary mirror 7 to be oriented toward the secondary mirror 8. The support of the secondary mirror 8 is advantageously also fitted with a mechanism (not represented) for adjusting the orientation of the support of the secondary mirror to adjust the position of the secondary mirror relative to the primary mirror. These adjustment mechanisms enable collimation of the mirrors, that is to say alignment of the two mirrors.

The body 110 of the primary optical system 11 can accommodate a fan (not represented) for controlling the temperature of the primary mirror 7.

### Secondary Optical System

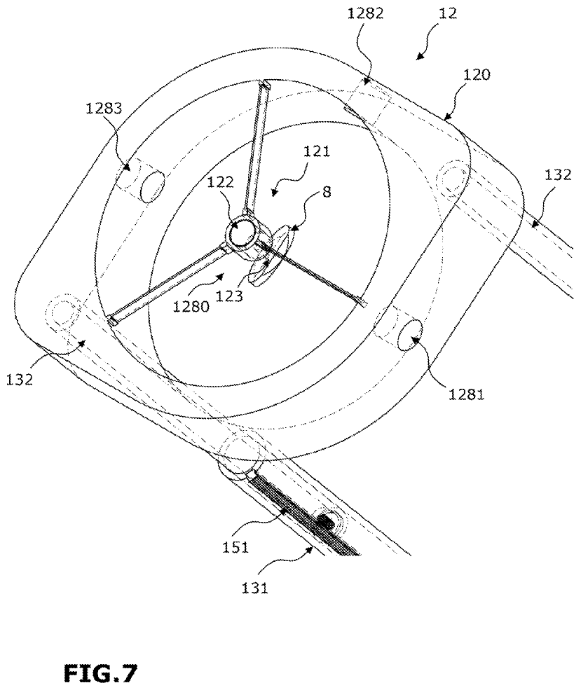

The secondary optical system 12 includes a body 120 that is fitted with a support 121 for the secondary mirror 8. In the example depicted in the figures and as more particularly depicted in FIG. 7 the support 121 for the secondary mirror includes a motor 122, such as a servomotor, having an output shaft 123 to which the secondary mirror 8 is fixed.

In accordance with one embodiment the driven shaft 123 to which the secondary mirror 8 is fixed forms an angular orientation system 1280 for the mirror. Indeed, the secondary mirror is inclined relative to the shaft 123. Rotation of the output shaft therefore changes the orientation of the secondary mirror and directs it toward to a required observation orifice 1281, 1282 or 1283.

In the example depicted in the figures the body 120 therefore includes a plurality of, for example, three, observation orifices.

In accordance with a particular aspect the telescope includes a system for observation of the secondary mirror. The telescope can therefore be equipped with various observation devices (not represented) each associated with an observation orifice. The observation devices may include an eyepiece support for direct observation by eye, a digital photography reflex box or a CCD-type digital video camera. The or each observation device can be mounted to be mobile so as to be able to move toward or away from the secondary mirror 8 to facilitate focusing.

The advantage of being able to rotate the secondary mirror 8 by means of the associated motor is to limit manipulation of the telescope by the user when the telescope is operating.

Alternatively, the secondary mirror may remain fixed and it is the observation devices that are movable, to be selectively positioned facing the same observation orifice associated with the secondary mirror.

### Separation Adjustment System

The separation adjustment system 13 enables adjustment of the separation between the body 110 of the primary optical system 11 and the body 120 of the secondary optical system 12.

The separation adjustment system 13 therefore enables adjustment of the distance between the primary mirror 7 carried by the support 113 and the secondary mirror 8 carried by the support 121 and thus adaptation of the focal length of the telescope as a function of the characteristics of the primary mirror 7 used and in particular as a function of its diameter.

In one embodiment the separation adjustment system 13 includes one or more interior telescopic tubes 132 mounted to slide relative to one or more exterior telescopic tubes 131. In other words the adjustment system 13 includes a system of tubes nesting telescopically. In the example depicted in the figures the adjustment system 13 includes two sets of telescopic tubes situated on respective opposite sides of the longitudinal axis A100 of the optical assembly 100 of the telescope. Each set of telescopic tubes includes an exterior tube 131 and an interior tube 132 mounted to slide relative to the exterior tube 131.

The adjustment system 13 also includes a system for driving the interior telescopic tube or tubes 132 relative to the exterior telescopic tube or tubes 131. The system for driving the interior telescopic tube or tubes 132 relative to the exterior telescopic tube or tubes 131 may include one or more motors or actuators, for example a lead screw or a piston rod to actuate the movement of the interior tube or tubes in the direction of deployment or retraction relative to the corresponding exterior tube or tubes.

In the example depicted in the figures the exterior tube 131 has one end fixed to the body 110 of the primary optical system 11 and each interior tube 132 has one end fixed to the body 120 of the secondary optical system 12.

Each exterior tube 131 is carried by the fork-block 19 that is part of the support structure 900 described hereinafter, being mounted on and sliding relative to the fork-block 19 thanks to a balancing adjustment system 15 described hereinafter. In particular, the fork-block 19 has through-passages 193 in it through which the exterior tubes 131 extend.

In accordance with one embodiment each motor or each actuator of the separation adjustment system 13 is fixed to the body 110 of the primary optical system 11 to which each exterior tube 131 is also fixed and the corresponding interior tube 132, which is coupled to the body 120 of the secondary optical system 12, is coupled to the lead screw or the piston rod of the motor or the actuator.

Actuation of the motors or the actuators of the separation adjustment system 13 therefore drives the deployment or the retraction of the interior tubes 132 relative to the exterior tubes 131 and therefore the movement of the body 120 of the secondary optical system 12 away from or toward the body 110 of the primary optical system 11, which therefore modifies the distance between the primary mirror 7 and the secondary mirror 8.

### Fork-Block

The telescope includes a connecting body 19, also known as the fork-block, through which extends the optical assembly 100, in particular the exterior tubes 131. The fork-block is part of the support structure 900 that supports the optical assembly 100.

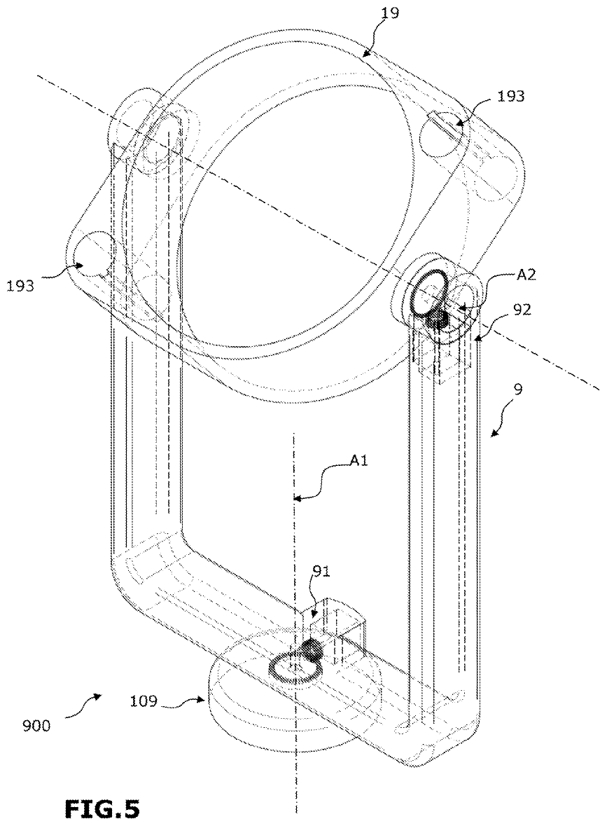

As depicted in FIG. 5 the fork-block 19 is articulated to the fork 9 described hereinafter about an axis A2.

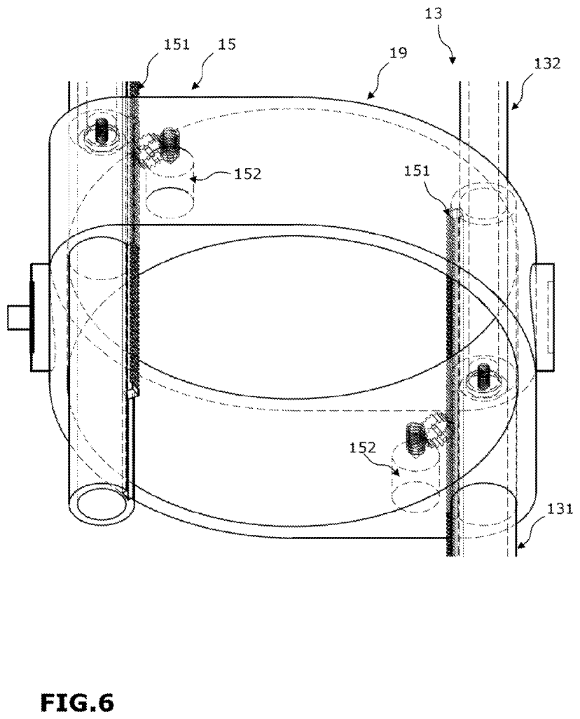

As depicted in FIG. 6 the telescope 1 also includes a balancing adjustment system 15 for adjusting the position of the optical system 100 by sliding the optical assembly 100 relative to the fork-block 19. In other words the balancing adjustment system 15 enables movement relative to the support structure of the assembly formed by the primary optical system, the secondary optical system and the separation adjustment system 13.

In particular, the balancing adjustment system 15 enables the primary optical system 11 to be moved toward or away from the fork-block 19 as a function of one or more characteristics of the primary mirror used. As mentioned hereinabove the primary mirror may have different sizes, in particular different diameters.

The balancing adjustment system 15 enables the optical assembly 100 to be balanced on the support structure 900. The position of the optical assembly 100 is preferably adjusted in such a manner as to obtain an equilibrium position of said optical assembly 100 that is substantially horizontal.

In the example depicted in the figures the adjustment system 15 includes a rack system 151 carried by the separation adjustment system 13 and a drive means 152 carried by the fork-block 19.

As depicted in FIG. 6 the rack system 151 may include a rack fixed to each exterior tube of the separation adjustment system 13 and the drive system 152 may include a motor for each rack the output shaft of which, of the lead screw type, is configured to drive gears that cooperate with teeth of the rack fixed to the corresponding exterior tube.

### Support Structure

The fork-block 19 is carried by a foot 9 also known as a fork. As FIG. 5 depicts the fork 9 is U-shaped.

The fork-block 19 is mounted to pivot on the free ends of the fork 9 about the horizontal axis A2 that is orthogonal to the longitudinal axis A100 of the optical assembly 100.

A drive system 92 enables the fork-block 19 and therefore the optical system 100 to be pivoted about the horizontal axis A2 to track observation up or down. The drive system 92 is preferably housed in the fork 9 at the level of the pivot connection of the fork-block to the fork.

The fork 9 is itself mounted on a base 109 to pivot about a vertical axis A1. The pivot axis A1 of the fork 9 passes through the middle of the fork 9 so that the fork 9 is able to turn on itself. Its drive system 91, preferably housed in the fork 9, enables the fork 9 to be driven in rotation relative to the base 109.

The support structure 900 of the telescope, which thus enables orientation of the optical system by pivoting about two mobility axes, therefore enables tracking of the observation of an object in the sky.

### Primary Mirror Retaining System

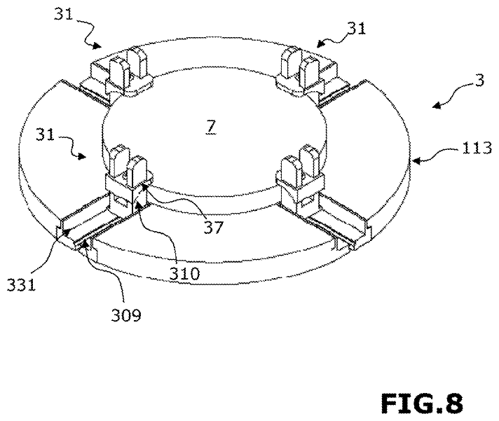

As FIG. 8 depicts the retaining system 3 enables the primary mirror 7 to be retained on the support 113 of the primary mirror support system 11.

The retaining system 3 is adjustable to delimit a housing of adjustable diameter so as to be able to replace a first primary mirror 7 by a second primary mirror 7′ that has a different diameter than the first primary mirror.

The adjustable retaining system 3 may be able to receive, in place of a first primary mirror, a second primary mirror that also has a thickness and/or a curvature different from that or those of the first primary mirror.

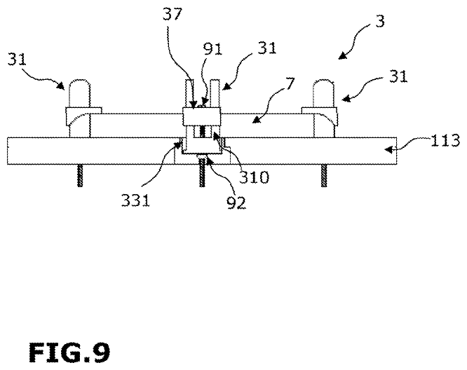

In accordance with the embodiment depicted in the figures and more particularly in FIG. 8 or 9 the retaining system 3 includes a plurality of retaining devices 31 mounted to be mobile, preferably continuously mobile.

In the example depicted in the figures the retaining devices 31 are movable along slides 331 between an apart position and a together position relative to one another, preferably in the direction of the same point corresponding to the center of the primary mirror.

Each slide 331 is preferably oriented with the other slides toward the center of the support 113, the slides preferably being distributed regularly, for example at 90°, around the center of the support.

Each retaining device 31 includes a lateral jaw 310 adapted to come to abut against the edge of the primary mirror 7 and a top jaw 37 adapted to come into abutment against the reflecting face of the primary mirror 7.

The lateral jaw 310 of the retaining device 31 extends perpendicularly to the mean plane of the support 113. In the example depicted in the figures the lateral jaw 310 is U-shaped.

The top jaw 37 includes a retaining lug mounted to slide along the lateral jaw 310.

The vertical jaw 37 projects from the lateral jaw 310 toward the center of the support 113 to form an abutment bearing against the upper face of the primary mirror.

In the embodiment depicted in FIGS. 8 and 9 each retaining device 31 is fitted with a locking mechanism that enables locking of the position of the retaining device 31 on the support 113.

The locking mechanism may include a nut-and-bolt type assembly. Thus the locking mechanism includes a clamping bolt 91 (also known as a clamping screw) and a nut 92 trapped in a groove 309 and cooperating with the shank of the bolt 91. The top of the groove 309 communicates with the guide rail (slide) 331. The bottom of the groove 309 is open to allow passage of the end of the bolt 91 opposite the head of the bolt that is in contact with the retaining lug of the top jaw 37.

The upper and lower openings of the groove 309 each have a width smaller than that of the area of the groove that accommodates the nut 92 to retain the latter in the groove. The groove may be open at one longitudinal end to open onto the peripheral perimeter of the support 113 to enable mounting of the nut in the groove.

Tightening the bolt 91 therefore drives the top jaw 37 to bear on the primary mirror and the nut 92 to bear against the upper edges of the groove 309 so that the jaw system 310, 37 is immobilized.

The locking mechanism may be common to the retaining devices 31 and/or the locking mechanism may enable simultaneous or synchronized bringing of each retaining device against the primary mirror.

### Control Unit

The telescope may be fitted with a control unit (not represented). The control unit enables control of some or all of the electronic system of the telescope, such as the separation adjustment system 13, the balancing adjustment system 15, the system for orienting the secondary mirror and/or the drive systems 91, 92 driving pivoting of the optical assembly about the axis A1, A2.

The telescope may include a distance sensor system for measuring the distance between the primary optical system 11 and the secondary optical system 12. The telescope may include an angular sensor system for measuring the inclination of the optical assembly 100 relative to the fork or to the base of the support structure 900.

In accordance with one embodiment the telescope includes a human-machine interface including a control panel for controlling some or all of the adjustment or orientation and/or drive systems of the telescope.

In particular, the user may be able to enter one or more characteristics of the primary mirror installed, such as its diameter, and the control unit to control the separation adjustment system 13, the balancing adjustment system 15 for automatic adjustment of the system between the primary mirror and the secondary mirror in order for the secondary mirror to be at the optical focus of the primary mirror, and/or automatic adjustment of the position of the optical assembly 100 relative to the fork-block 19 to obtain a horizontal equilibrium position.

For adjusting the position of the center of gravity of the optical assembly relative to the support structure the drive system 92 for pivoting the optical assembly 100 about the axis A2 may be controlled to render the optical assembly 100 horizontal with the aid of a sensor system enabling measurement of the angle of the optical assembly 100 relative to the horizontal. The control unit can then command a reduction of the footprint of the drive system 92 on the fork-block and movement of the position of the optical assembly 100 relative to the fork-block 19, that is to say along the longitudinal axis A100 of the optical assembly 100, to identify the horizontal equilibrium position of the optical assembly 100 relative to the support structure with the aid of the angle sensor system.

Alternatively, the various adjustments and orientations may be performed by hand.

The control unit may take the form of a data processor and a memory in which are stored instructions that can be executed by said processor or the form of a microcontroller.

In particular, the functions and steps executed by the control unit may be implemented by sets of instructions or software modules implemented in a processor or controller or be produced by dedicated electronic components or components of FPGA or ASIC type. It is also possible to combine data processing parts and electronic parts.

The control unit is therefore an electronic and/or computer unit. When it is stated that said unit is configured to execute a given operation, this means that the unit includes instructions and corresponding execution means enabling said operation to be executed and/or that the unit includes corresponding electronic components.

### Method

The telescope described hereinabove enables use of a method of mounting a second primary mirror 7′ instead of a first primary mirror 7 in a telescope as described hereinabove.

The method includes the following steps. When a primary mirror 7 is initially present, as depicted in FIG. 1, the user deactivates the adjustable retaining system 3 (step 1010) to remove the first primary mirror 7 from the primary optical system 11. With the adjustable retaining system 3 depicted in FIGS. 8 and 9 the user can, for each retaining device 31, loosen the system formed of the bolt 91 and the nut 92 to raise the top jaw 37 and move the whole of the corresponding retaining device 31 back along the groove (slide) 331 relative to the mirror to be removed.

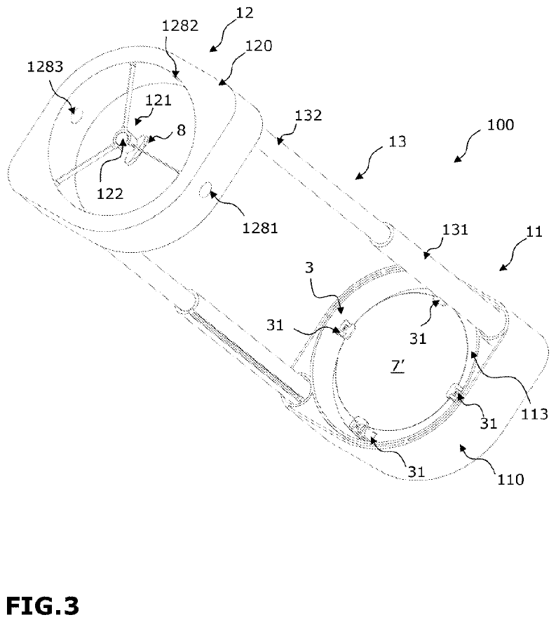

As depicted in FIG. 3 the second primary mirror 7′ is then positioned on the support 113 with the retaining system 3 adjusted to hold the second primary mirror 7′ in position (step 1020). The lateral and vertical jaws of each retaining device 31 are therefore moved closer against the contour of the mirror, after which the corresponding locking mechanism 91, 92 is activated.

In step 1030 the separation between the second primary mirror 7′ and the secondary mirror 8 is then adjusted as a function of the diameter of the second primary mirror 7′ to position the secondary mirror at the optical focus of the second primary mirror.

The collimation process that corresponds to the alignment of the primary mirror with the secondary mirror and the observation device may be effected by the user via the collimation mechanism associated with the primary mirror support 113 that may include a system of studs including springs and bolts enabling the sides of the mirror to be raised (by unscrewing) or lowered (by screwing in).

The position of the optical assembly 100 can then be adjusted relative to the fork-block 19 to balance the optical assembly 100 on the support structure so that in equilibrium the longitudinal axis A100 of the optical assembly 100 is substantially horizontal.

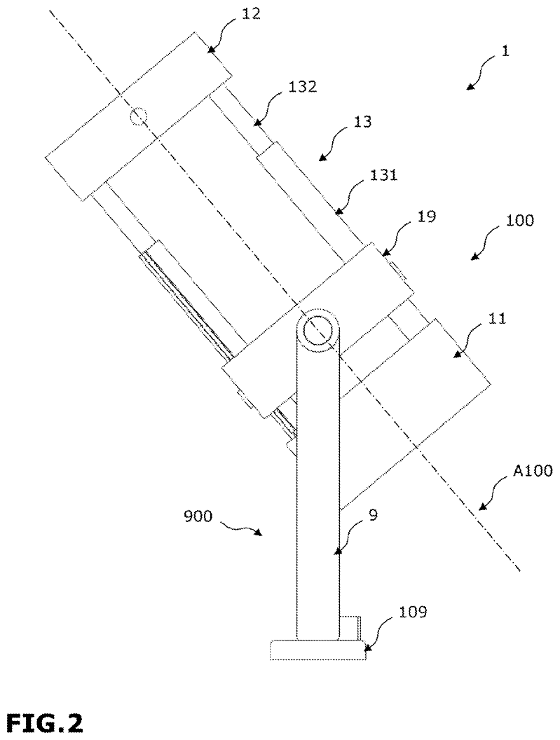

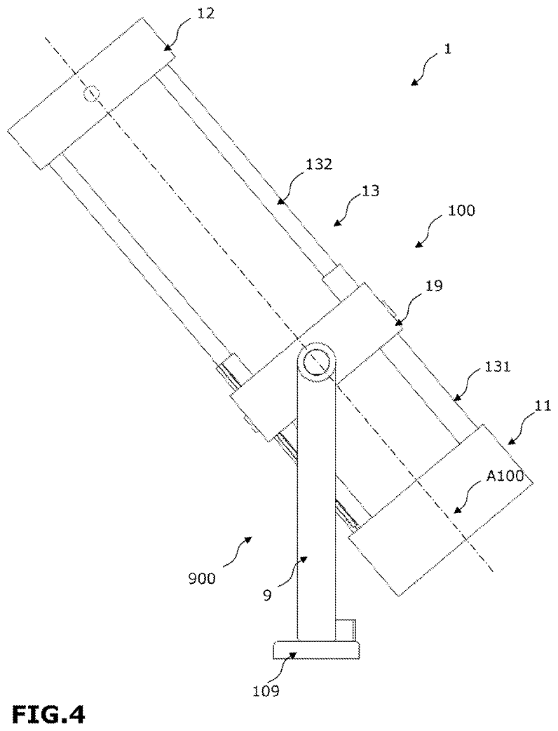

As depicted in FIGS. 1 to 4 a user can therefore replace the primary mirror 7 of the telescope from FIG. 1 with another primary mirror 7′ of greater diameter (FIG. 3).

The telescope can thus be made able to receive a primary mirror that has a diameter between 150 mm and 300 mm inclusive. The secondary mirror may have a diameter between 31 mm and 88 mm inclusive without it being necessary to change the secondary mirror when the primary mirror is changed.

The distance between the faces of the primary and secondary mirrors may be adjustable between 750 mm and 1200 mm by the action of the system of telescopic tubes. For the balancing positioning of the optical assembly the distance between the support of the primary mirror and the point of rotation of the fork-block at the junction of the fork may be adjusted over a range of 250 mm thanks to the system of racks.

The telescope therefore offers the benefit of a consumer grade reflector telescope of modular design in the sense that it is capable of selectively receiving different sizes of primary mirrors thanks to the adjustable retaining system that comprises tightening devices the positions of which can be adjusted to adapt to the diameter and to the thickness of the primary mirror.

The invention is not limited to the embodiments depicted in the drawings.

Furthermore, the term “including” does not exclude other elements or steps. Furthermore, features or steps that have been described with reference to one of the embodiments disclosed hereinabove may equally be used in combination with other features or steps of other embodiments disclosed hereinabove.

1. A telescope including:
a primary optical system including a primary mirror support for receiving a primary mirror, also known as an objective;
a secondary optical system including a secondary mirror support for receiving a secondary mirror; and
a separation adjustment system enabling adjustment of the distance between the primary mirror support and the secondary mirror support;
characterized in that, the primary optical system including a primary mirror retaining system enabling retention of a primary mirror on the primary mirror support, the primary mirror retaining system is adjustable in such a manner as to be able to delimit different sizes of the space to receive the primary mirror on the primary mirror support.

2. The telescope as claimed in claim 1, wherein the separation adjustment system includes:
a system of telescopic tubes comprising one or more interior telescopic tubes mounted to slide relative to one or more exterior telescopic tubes, and
a mechanism for driving the interior telescopic tube or tubes relative to the exterior telescopic tube or tubes.

3. The telescope as claimed in claim 1, wherein the primary optical system, the secondary optical system and the separation adjustment system form an optical assembly that has a longitudinal axis and the telescope also includes a support structure that includes:
a foot, also known as a fork; and
a connecting body, also known as a fork-block, that carries the optical system, said fork-block being articulated to the fork about an axis orthogonal to the longitudinal axis of the optical assembly.

4. The telescope as claimed in claim 3, wherein the telescope includes an adjustment system for balancing the optical assembly relative to the support structure by sliding the optical assembly parallel to its longitudinal axis.

5. The telescope according to claim 4, wherein the separation adjustment system includes;
a system of telescopic tubes comprising one or more interior telescopic tubes mounted to slide relative to one or more exterior telescopic tubes, and
a mechanism for driving the interior telescopic tube or tubes relative to the exterior telescopic tube or tubes,
and wherein the balancing adjustment system includes a rack system carried by the exterior tube or tubes of the telescopic tube system and a drive system carried by the fork-block.

6. The telescope as claimed in claim 1, wherein the adjustable retaining system of the primary mirror includes a plurality of retaining devices mounted to be mobile between an apart position and a together position relative to one another to enable delimitation of different sizes of the space for receiving the primary mirror.

7. The telescope as claimed in claim 6, wherein each retaining device is provided with a locking mechanism to enable locking in position of the retaining device on the support of the primary mirror.

8. The telescope as claimed in claim 6, wherein each retaining device includes a lateral jaw that is movable on the support of the primary mirror to come into abutment against the edge of the primary mirror and a top jaw movable relative to the lateral jaw to come into abutment against a reflecting face of the primary mirror.

9. The telescope according to claim 1, wherein the secondary optical system includes at least one observation orifice to enable observation of the secondary mirror.

10. The telescope as claimed in claim 9, wherein the secondary optical system includes a mechanism for orienting the secondary mirror toward the observation orifice.

11. The telescope as claimed in claim 9, wherein the telescope includes at least one observation devices selected from the group consisting of:
an eyepiece support for direct by eye observation;
a photography reflex box; and
a CCD-type video camera;
the or each observation device being associated with the or each observation orifice of the secondary optical system toward which the secondary mirror is oriented or orientable.

12. The telescope as claimed in claim 1, wherein the telescope includes the secondary mirror.

13. The telescope as claimed in claim 1, wherein the telescope includes the primary mirror.

14. A method of mounting a second primary mirror in place of a first primary mirror in the telescope as claimed in claim 1, the telescope including a secondary mirror carried by the secondary mirror support, wherein the method comprises:
deactivating the adjustable retaining system to remove the first primary mirror from the primary mirror support of the primary optical system;
adjusting the retaining system to position the second primary mirror and to retain the second primary mirror on the support of the primary mirror of the primary optical system;
adjusting the separation between the second primary mirror and the secondary mirror as a function of at least one dimension of the second primary mirror.

15. The method as claimed in claim 14, further comprising adjusting the balance position of the optical assembly that includes the primary optical system, the separation adjustment system, and the secondary optical system, relative to a support structure that the optical assembly carries.

16. The telescope as claimed in claim 6, wherein the retaining devices are mounted to be continuously mobile between the apart position and the together position relative to one another.

17. The telescope as claimed in claim 7, wherein the locking mechanism is formed by a nut-and-bolt type assembly cooperating with a groove formed in the support of the primary mirror, to enable locking in position of the retaining device on the support of the primary mirror.

18. The telescope according to claim 8, wherein the secondary optical system includes a plurality of observation orifices to enable observation of the secondary mirror.

19. The telescope as claimed in claim 18, wherein the secondary optical system includes a mechanism for orienting the secondary mirror toward any one of the observation orifices.

20. The telescope as claimed in claim 19, wherein the orientation mechanism includes a motor coupled to a shaft to which the secondary mirror is fixed.
